(19) United States
(12) Patent Application Publication
(10) Pub. No.: US 2014/0263031 A1
(43) Pub. Date: Sep. 18, 2014

(54) POOL HANDLE ATTACHMENT MECHANISM AND METHODS THEREOF

(71) Applicant: Stout Stuff, LLC, Bentonville, AR (US)

(72) Inventors: Thomas Lawson, Rogers, AR (US); Christopher E. Chance, Bella Vista, AR (US); Timothy Hart, Rogers, AR (US); Andrew Bojie, Centerton, AR (US)

(73) Assignee: Stout Stuff, LLC, Bentonville, AR (US)

(21) Appl. No.: 14/217,366

(22) Filed: Mar. 17, 2014

Related U.S. Application Data
(60) Provisional application No. 61/801,352, filed on Mar. 15, 2013.

(51) Int. Cl. B25G 3/26; F16B 9/02; B25G 1/00; E04H 4/16; A01D 7/00

(52) U.S. Cl. CPC B25G 3/26; E04H 4/1609; A01D 7/00; B25G 1/00; F16B 9/023
USPC 210/470; 15/144.1; 56/400.01; 16/422; 403/330; 15/415.1

(57) ABSTRACT

A pole attachment mechanism for removably attaching swimming pool maintenance accessories to an end of a pole. The pole attachment mechanism includes a thumb-press which, when pressed, the pegs projecting from the shaft of the pole attachment are retracted thereby permitting the pole to be received over the retracted pegs or to be released from pegs.

### BACKGROUND

Swimming pools require considerable maintenance to keep the water clean and inviting. Typical equipment used for cleaning and maintaining pools include hand skimmers, leaf rakes, wall brushes, vacuum heads and the like. Each of these pool maintenance or cleaning accessories attaches to an end of a long pole which allows the user to stand or walk around the pool deck while reaching down into the pool to vacuum or rake debris from the bottom of the pool or to reach out over the pool to skim floating debris from the water surface.

The conventional method of attaching the pole to the accessory requires a shaft on the accessory to be inserted into one end of the pole. To lock the accessory to the pole, the shaft of the accessory includes a resilient clip (typically made of plastic) having pegs which project outwardly from the shaft. To slide the pole over the shaft, the projecting pegs must be pressed with one hand (typically using the thumb and index finger), while at the same time sliding the end of the pole over the pressed-in pegs. Once the pole is received over the shaft, mating holes near the end of the pole must be aligned with the pegs, permitting the pegs to snap out through the holes, thereby locking the accessory to the end of the pole. To remove the accessory from the pole, the user must again press in the pegs projecting through the pole while pulling or pushing the accessory away from the pole.

While the resilient clip serves its intended purpose, some users find it difficult to press in the pegs projecting from the accessory shaft when attempting to attach the accessory or to remove the accessory from the end of the pole. Additionally, it is cumbersome to try to place the end of the pole over the pegs while at the same time pressing in on the pegs. Often the skin of the thumb and fingers will get pinched between the edge of the pole and the pegs when attempting to push the end of the pole over the pressed in pegs.

Accordingly, there is a need for an improved pole attachment mechanism for swimming pool maintenance accessories which overcomes the foregoing difficulties, but which still locks to standard poles in substantially the same manner utilizing pegs which snap into the peg holes near the end of the pole.

### BRIEF DESCRIPTION OF THE DRAWINGS

FIG. 1 is a perspective view of one embodiment of a pole attachment mechanism for a swimming pool maintenance accessory comprising a vacuum head.

FIG. 2 is a perspective view of another embodiment of the pole attachment mechanism for a swimming pool maintenance accessory comprising a hand skimmer.

FIG. 3 is a perspective view of another embodiment of the pole attachment mechanism for a swimming pool maintenance accessory comprising a leaf rake.

FIG. 4 is a perspective view of another embodiment of the pole attachment mechanism for a swimming pool maintenance accessory comprising a wall brush.

FIG. 5 is a top perspective view of the pole attachment mechanism of FIG. 1.

FIG. 6 is a side elevation view of the pole attachment mechanism of FIG. 5.

FIG. 7 is a bottom perspective view of the pole attachment mechanism of FIG. 5.

FIG. 8 is an exploded perspective view of the pole attachment mechanism of FIG. 7.

FIG. 9 is the same bottom perspective view of the pole attachment mechanism as in FIG. 5, except showing the pole received over the shaft of the pole attachment mechanism.

FIG. 10 is an enlarged perspective view of an embodiment of a clip.

FIG. 11 is a top perspective view of the pole attachment mechanism of FIG. 5 locked with respect to the end of a pole.

FIG. 12 is a bottom perspective view of the pole attachment mechanism and pole of FIG. 11.

### DESCRIPTION

Referring now to the drawings wherein like reference numerals designate the same or corresponding parts throughout the several views, FIG. 1 is a perspective view of a swimming pool maintenance accessory 10 comprising a vacuum head 10A. FIG. 2 is a perspective view of a swimming pool maintenance accessory 10 comprising a hand skimmer 10B. FIG. 3 is a perspective view of a swimming pool maintenance accessory 10 comprising a leaf rake 10C. FIG. 4 is a perspective view of a swimming pool maintenance accessory 10 comprising a wall brush 10D. The examples of the accessories 10 shown in FIGS. 1 to 4 are for illustration purposes only, and it should be understood that the accessories 10 may be any other type of swimming pool maintenance accessory to which a pole may be attached.

With respect to FIG. 1, the vacuum head accessory 10A includes a base A1 having a vacuum port A2 projecting upwardly from the base. In use, a vacuum hose A3 attaches to the vacuum port A4. The base A1 includes upwardly projecting ears A5 having aligned apertures A6. A pole attachment mechanism 100A is provided to removably attach the vacuum head accessory 10A to a pole 20. In this embodiment, the pole attachment mechanism 100A includes a clevis end for pivotally attaching to the vacuum head accessory 10A (discussed later).

With respect to FIG. 2, the hand skimmer 10B includes a base B1 in the form of a peripheral frame to which a mesh or net material B2 is attached. A pole attachment mechanism 100B is provided to removably attach the hand skimmer accessory 10B to a pole 20. In this embodiment, the pole attachment mechanism 100B is substantially the same as pole attachment mechanism 100A except that the pole attachment mechanism 100B is fixed to or formed integral with the base B1 instead of utilizing a clevis end.

With respect to FIG. 3, the leaf rake 10C includes a base C1 in the form of a peripheral frame to which a mesh or net material C2 is attached. A pole attachment mechanism 100C is provided to removably attach the leaf rake 10C to a pole 20. In this embodiment, the pole attachment mechanism 100C is substantially the same as pole attachment mechanism 100B and is fixed to or formed integral with the base C1.

With respect to FIG. 4, the wall brush 10D includes a base D1 in the form of a brush head. A pole attachment mechanism 100D is provided to removably attach the wall brush 10D to a pole 20. In this embodiment, the pole attachment mechanism 100D is substantially the same as pole attachment mechanism 100B and is fixed to or formed integral with the base D1.

FIG. 5 is a top perspective view of one embodiment of the pole attachment mechanism 100A for attaching the pole to a vacuum head accessory 10A. FIG. 7 is a bottom perspective view of the pole attachment mechanism 100A of FIG. 5. FIG. 6 is a side elevation view of the pole attachment mechanism 100A. The pole attachment mechanism 100A comprises a tubular shaft 102 having a distal end 104 sized to be received into the end of the pole 20. The proximal end 106 of the tubular shaft 102 includes a clevis 108 sized to receive the upwardly projecting ears AS on the base A1 of the vacuum head accessory 10A. A pin 110 extends through aligned apertures 112 in the clevis 108 and through the aligned apertures A6 in the upwardly projecting ears A5, thereby securing the tubular shaft 102 to the accessory 10A.

Referring to FIGS. 7-10, the tubular shaft 102 of the attachment mechanism 100 includes a clip 120 received within an open segment 114 of the tubular shaft 102. The clip 120 includes a pair of outwardly projecting pegs 122 which extend from a pair of resilient legs 124 which diverge apart from a vertex 128 forming a V-shape. The vertex 128 includes an enlarged head 130 providing a thumb-press (discussed later). As best illustrated in FIG. 8, the tubular shaft 102 includes a pair of apertures 116 through which the pegs 122 extend (see FIG. 7). Within the open segment 114 is a pair of inwardly projecting rounded ears 118. When an inward force F (e.g., a downward force as shown in FIG. 7) is applied to the enlarged head 130 or vertex 128, the diverging legs 124 are forced between the inwardly projecting rounded ears 118. The legs are forced inwardly by the ears 118 thereby causing the pegs 122 at the ends of the legs 124 to retract or be pulled inwardly permitting the end of the pole 20 to pass over the retracted pegs 122. When the force F is removed or released, the biasing force of the outwardly diverging resilient legs 124 will spring back from between the rounded ears 118 to their original position thereby causing the pegs 122 to be forced outwardly. When the peg apertures 22 in the pole 20 become longitudinally and rotationally aligned with the pegs 122, the pegs snap out through the peg apertures, locking the tubular shaft 102 to the pole 20, which, in turn, locks the accessory 100 to the pole 20.

To assist in aligning the pegs 122 with the peg apertures 22 in the pole 20, the distal end of the tubular shaft 102 includes a transverse slot 140. The transverse slot 140 is configured to receive a pin 142 extending transversely through the pole 20 at the proper distance from the end of the pole so that the transverse pin 142 and transverse slot 140 cooperate to both longitudinally and rotationally align the pegs 122 in the shaft 102 with the peg apertures 22 in the pole 20 so the pegs 122 will snap out through the peg apertures 22 locking the pole to the tubular shaft 102.

Thus, as with the conventional means of attaching the shaft 102 to the pole 20, the distal end 104 of the tubular shaft 102 is inserted into the end of the pole until the end of the pole abuts the pegs 122 projecting from the shaft 102. However, unlike the convention method, rather than pressing the projecting pegs inwardly by hand to enable the shaft to extend deeper into the pole, one can simply press the enlarged head with one's thumb to retract the pegs 122. This thumb-press action is much easier than attempting to push the pegs in between one's thumb and forefinger and avoids pinching of the skin on the fingers common with the conventional method.

FIG. 11 is a top perspective view showing the pole attachment mechanism 100A received and locked within the end of the pole 20. FIG. 12 is a bottom perspective view showing the pole attachment mechanism 100A received and locked within the end of the pole 20. In reference to FIG. 12, it should be appreciated the enlarged head 130 extends a distance beyond the end of the pole 20, providing a convenient thumb-press for depressing the head 130 to retract the pegs 122 permitting the shaft to be easily inserted into the end of the pole or easily removed from the end of the pole.

Various embodiments of the invention have been described above for purposes of illustrating the details thereof and to enable one of ordinary skill in the art to make and use the invention. The details and features of the disclosed embodiments are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A pole attachment mechanism for swimming pool maintenance accessories, the pole attachment mechanism comprising:
(A) a tubular shaft having a distal end and a proximal end, the tubular shaft having longitudinal central axis and a lateral central axis, the tubular shaft including:
(i) a pair of apertures substantially aligned along the longitudinal central axis and proximate the central lateral axes;
(ii) an outer surface with an open wall segment exposing an interior cavity of the tubular shaft, the interior cavity including:
(a) a pair of opposing inwardly projecting ears substantially aligned along the longitudinal central axis, the opposing inwardly projecting ears defining a lateral space therebetween, the inwardly projecting ears spaced a distance longitudinally from the apertures in a direction toward the proximal end of the tubular shaft;
(B) a clip including:
(i) a pair of resilient legs extending longitudinally from and diverging laterally outwardly from a vertex;
(ii) a peg extending laterally outwardly from a distal end of each of the legs, each of the pegs having outer ends;
wherein the legs of the clip extend into the interior cavity of the tubular shaft with the outer ends of the pegs projecting through the apertures and extending outwardly from the outer surface of the tubular shaft, the laterally outwardly diverging legs biasing the peg ends outwardly;
wherein a distance from the pegs at the distal ends of the legs to the vertex is greater than the longitudinal distance between the apertures and the inwardly projecting ears;
wherein the vertex of the legs of the clip is oriented toward the proximal end of the tubular shaft;
wherein a width between the laterally diverging legs of the clip at a location where the legs extend past the inwardly projecting ears is greater than the lateral space between the ears;
wherein the lateral space between the ears is such that when an inward force is applied to the vertex of the legs to force the legs between the inwardly projecting ears, the distal end of the legs are drawn inwardly a sufficient distance such that the outer ends of the pegs are substantially flush with the outer surface of the tubular shaft.

2. The pole attachment mechanism of claim 1 wherein the proximal end of the shaft includes a clevis end adapted to pivotally attach to the swimming pool maintenance accessory.

3. The pole attachment mechanism of claim 1 wherein the swimming pool maintenance accessory is a vacuum head.

4. The pole attachment mechanism of claim 1 where in the proximal end of the shaft is fixed to a base of the swimming pool maintenance accessory.

5. The pole attachment mechanism of claim 4 wherein the swimming pool maintenance accessory is a hand skimmer.

6. The pole attachment mechanism of claim 4 wherein the swimming pool maintenance accessory is a wall brush.

7. The pole attachment mechanism of claim 4 wherein the swimming pool maintenance accessory is a leaf rake.

8. The pole attachment mechanism of claim 1 in combination with a pole, wherein the pole is sized to slidably receive the distal end of the tubular shaft.

9. The pole attachment mechanism of claim 8 wherein the pole includes peg apertures which mateably align with the peg ends projecting outwardly from the tubular shaft, whereby when the peg apertures align with the peg ends, the outwardly biased peg ends snap into the peg apertures, removably locking the pole to the pole attachment mechanism.

10. The pole attachment mechanism of claim 9 wherein the vertex of the legs extends a distance beyond the end of the pole when the peg ends are received within the peg apertures of the pole.

11. The pole attachment mechanism of claim 10 wherein a distal end of the tubular shaft includes a transverse slot and the pole includes a transverse pin, whereby the transverse pin and transverse slot cooperate to longitudinally and rotationally align the peg apertures with the peg ends when the transverse pin is received within the transverse slot.

12. The pole attachment mechanism of claim 11 wherein the proximal end of the tubular shaft includes a clevis end adapted to pivotally attach to the swimming pool maintenance accessory.

13. The pole attachment mechanism of claim 12 wherein the swimming pool maintenance accessory is a vacuum head.

14. The pole attachment mechanism of claim 11 where in the proximal end of the shaft is fixed to a base of the swimming pool maintenance accessory.

15. The pole attachment mechanism of claim 14 wherein the swimming pool maintenance accessory is a hand skimmer.

16. The pole attachment mechanism of claim 14 wherein the swimming pool maintenance accessory is a wall brush.

17. The pole attachment mechanism of claim 14 wherein the swimming pool maintenance accessory is a leaf rake.
